(19) United States
(12) Patent Application Publication
(10) Pub. No.: US 2025/0089893 A1
(43) Pub. Date: Mar. 20, 2025

(54) CHAIR OR POWER ASSIST RECLINER AND MULTILAYER SEATING ARRANGEMENT THEREOF

(71) Applicant: WORLDWIDE LIVE SHOPPING LLC, Aventura, FL (US)

(72) Inventor: Florencia Hane, Aventura, FL (US)

(21) Appl. No.: 18/368,590

(22) Filed: Sep. 15, 2023

(51) Int. Cl. A47C 1/034; A47C 1/032

(52) U.S. Cl. CPC A47C 1/0342; A47C 1/03211

(57) ABSTRACT

A lifting chair or power assist recliner (hereinafter referred to as “recliner”) includes a seating assembly having a seat and a supporting arrangement operatively coupled to the seating assembly. The seating assembly may include a multilayer comforting arrangement disposed on the seat for providing comfort to a user. The multilayer comforting arrangement comprises at least one layer of a cushioning material known as optron. Further, the supporting arrangement comprises a lifting arrangement operably secured to the supporting arrangement. The lifting arrangement mechanically actuates and lift or rotate the seating assembly at a pre-set level depending on the user's physique and comfort.

### CROSS REFERENCE TO RELATED APPLICATIONS

The present invention claims priority under 35 United States Code, Section 119 on the provisional application No. 63/407,172 filed on Sep. 16, 2022, the disclosure of which is incorporated by reference.

### FIELD OF INVENTION

The present invention relates to chairs or recliners generally, and, more particularly, a multilayer seating arrangement in a comfort chairs or recliners.

### BACKGROUND

Recliner chairs and lifting chairs have been available on the market for many years, with recliners serving primarily as furniture for living rooms and family rooms while lifting chairs are used by the elderly, disabled, and people with disabilities to help them transition from a seated to a standing position. People who want assistance getting from a seated to a standing posture frequently use power-controlled lifting recliner chairs.

Regular chairs and recliners may be uncomfortable and can lead to knee, neck, and lower back pain. Additionally, traditional chairs and recliners may not be elevated or provide greater level of comfort to a user.

As a result, in order to achieve the highest level of comfort, there are a number of issues that need to be resolved in relation to the traditional chairs or recliners.

### SUMMARY

In view of the foregoing disadvantages inherent in the prior art, the general purpose of the present invention is to provide chair or power assist recliner and multilayer seating arrangement thereof to include all advantages of the prior art, and to overcome the drawbacks inherent in the prior art.

In one aspect of the present invention, a lifting chair or power assist recliner (hereinafter referred to as “recliner”) includes a seating assembly having a seat and a supporting arrangement operatively coupled to the seating assembly. The seating assembly may include a multilayer comforting arrangement disposed on the seat for providing comfort to a user. The multilayer comforting arrangement comprises at least one layer of a cushioning material known as optron. Further, the supporting arrangement comprises a lifting arrangement operably secured to the supporting arrangement. The lifting arrangement mechanically actuates and lift or rotate the seating assembly at a pre-set level depending on the user's physique and comfort. The lifting arrangement is configured to actuate and rotate the seating assembly comprising the multilayer comforting arrangement according to comfort of the user.

The seating assembling may include a seat, a back rest, a leg supporting component, side arms. The seat may be aligned horizontally. The back rest may extend vertically upward from the seat. The leg supporting component may extends from the seat to be operatively aligned with the seat, and the side arms may extend vertically from sides of the seat. Each of the seat, the back rest, and the leg supporting component are comprises of the multilayer comforting arrangement having at least one layer of the cushioning material known as optron.

In one embodiment, the multilayer comforting arrangement comprises at least three layers, a first layer, a second layer, and a third layer. The second layer is sandwiched between the first layer and the third layer. The second layer is of the cushioning material known as the optron which when paired with the first layer and the third layer adds additional comfort and reduces fatigue. The first layer may be a fabric layer, and the third layer may be a memory foam.

One another embodiment, the multilayer comforting arrangement includes at least two layers, a top layer and a bottom layer. The top layer is disposed above a bottom layer. The top layer is of the cushioning material known as the optron which when paired with the bottom layer adds additional comfort and reduces fatigue. The bottom layer is a memory foam.

In one example, the seating assembly may be automatically rotated and actuated depending on the comfort of the user. In another example, the seating assembly may be manually operated using a remote control “R” for rotation and actuation depending on the comfort of the user.

The recliner further includes a heating and/or massaging member controlled by a remote control with heat and/or massage buttons, at least three USB ports, two or more cup holders, a side pocket, at least two front pockets arranged along the seating assembly.

In one another aspect of the present invention, a seating assembly for a lifting chair or power assist recliner is provided. The seating assembly includes a seat having a multilayer comforting arrangement disposed on the seat for providing comfort to a user, wherein the multilayer comforting arrangement comprises at least one layer of a cushioning material known as optron.

The seating assembling may include a seat, a back rest, a leg supporting component, side arms. The seat may be aligned horizontally. The back rest may extend vertically upward from the seat. The leg supporting component may extends from the seat to be operatively aligned with the seat, and the side arms may extend vertically from sides of the seat. Each of the seat, the back rest, and the leg supporting component are comprises of the multilayer comforting arrangement having at least one layer of the cushioning material known as optron.

In one embodiment, the multilayer comforting arrangement comprises at least three layers, a first layer, a second layer, and a third layer. The second layer is sandwiched between the first layer and the third layer. The second layer is of the cushioning material known as the optron which when paired with the first layer and the third layer adds additional comfort and reduces fatigue. The first layer may be a fabric layer, and the third layer may be a memory foam.

One another embodiment, the multilayer comforting arrangement includes at least two layers, a top layer and a bottom layer. The top layer is disposed above a bottom layer. The top layer is of the cushioning material known as the optron which when paired with the bottom layer adds additional comfort and reduces fatigue. The bottom layer is a memory foam.

These aspects of the present disclosure, along with the various features of novelty that characterize the present disclosure, are pointed in the below description. For a better understanding of the present disclosure, its operating advantages, and the specific objects attained by its uses, reference should be made to the accompanying drawing and descriptive matter in which there is illustrated an exemplary embodiment of the present disclosure.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 illustrates a perspective view of the lifting chair or power assist recliner with a leg supporting component open for feet raise, in accordance with an exemplary embodiment of the present disclosure;

FIG. 2 illustrates a perspective view of the lifting chair or power assist recliner with a closed leg supporting component, in accordance with an exemplary embodiment of the present disclosure;

FIGS. 3 and 4 illustrate perspective views of the lifting chair or power assist recliner with a lift, in accordance with an exemplary embodiment of the present disclosure;

FIG. 5 illustrates a perspective view of the lifting chair or power assist recliner and exploded view of a multilayer comforting arrangement, according to one embodiment of the present invention;

FIG. 6 illustrates a perspective view of the lifting chair or power assist recliner and exploded view of a multilayer comforting arrangement, according to another embodiment of the present invention; and

FIG. 7 illustrates a graph showing the compression set testing result of at least one layer of a cushioning material known as optron, according to embodiments of the present invention.

Like reference numerals refer to like parts throughout the description of several views of the drawings.

### DETAILED DESCRIPTION OF EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure.

In the following description, numerous specific details are set forth in order to provide a thorough understanding of embodiments of the present invention. It may be apparent to one skilled in the art that embodiments of the present invention may be practiced without some of these specific details.

Various terms as used herein are shown below. To the extent a term used, it should be given the broadest definition persons in the pertinent art have given that term as reflected in printed publications and issued patents at the time of filing.

The terms “a” and “an” herein do not denote a limitation of quantity, but rather denote the presence of at least one of the referenced items.

The terms “having”, “comprising”, “including”, and variations thereof signify the presence of a component.

In one aspect of the present invention, a lifting chair or power assist recliner (hereinafter referred to as “recliner”) includes a seating assembly having a seat and a supporting arrangement operatively coupled to the seating assembly. The seating assembly may include a multilayer comforting arrangement disposed on the seat for providing comfort to a user. The multilayer comforting arrangement comprises at least one layer of a cushioning material known as optron. Further, the supporting arrangement comprises a lifting arrangement operably secured to the supporting arrangement. The lifting arrangement mechanically actuates and lift or rotate the seating assembly at a pre-set level depending on the user's physique and comfort. The lifting arrangement is configured to actuate and rotate the seating assembly comprising the multilayer comforting arrangement according to comfort of the user. In one embodiment, the multilayer comforting arrangement comprises at least three layers, a first layer, a second layer, and a third layer. The second layer is sandwiched between the first layer and the third layer. The second layer is of the cushioning material known as the optron which when paired with the first layer and the third layer adds additional comfort and reduces fatigue. The first layer may be a fabric layer, and the third layer may be a memory foam. One another embodiment, the multilayer comforting arrangement includes at least two layers, a top layer and a bottom layer. The top layer is disposed above a bottom layer. The top layer is of the cushioning material known as the optron which when paired with the bottom layer adds additional comfort and reduces fatigue. The bottom layer is a memory foam.

In one another aspect of the present invention, a seating assembly for a lifting chair or power assist recliner is provided. The seating assembly includes a seat having a multilayer comforting arrangement disposed on the seat for providing comfort to a user, wherein the multilayer comforting arrangement comprises at least one layer of a cushioning material known as optron. In one embodiment, the multilayer comforting arrangement comprises at least three layers, a first layer, a second layer, and a third layer. The second layer is sandwiched between the first layer and the third layer. The second layer is of the cushioning material known as the optron which when paired with the first layer and the third layer adds additional comfort and reduces fatigue. The first layer may be a fabric layer, and the third layer may be a memory foam. One another embodiment, the multilayer comforting arrangement includes at least two layers, a top layer and a bottom layer. The top layer is disposed above a bottom layer. The top layer is of the cushioning material known as the optron which when paired with the bottom layer adds additional comfort and reduces fatigue. The bottom layer is a memory foam.

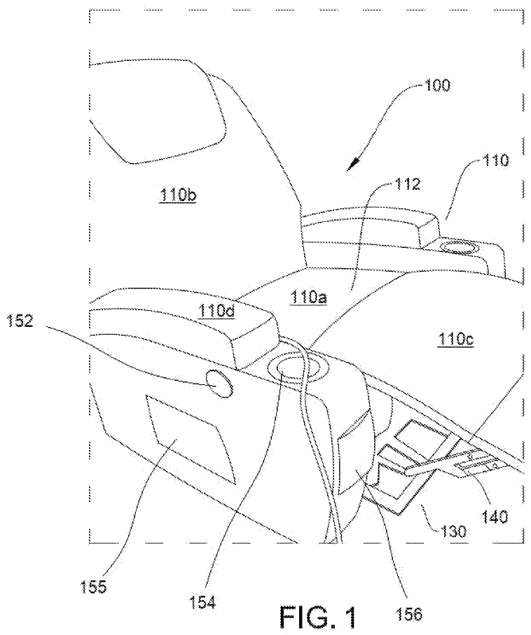

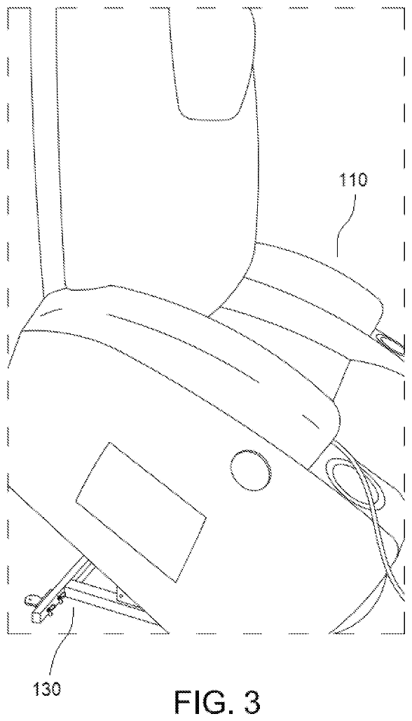

Referring now to FIGS. 1 to 8, a perspective view which shows the lifting chair or power assist recliner 100 is illustrated, in accordance with an exemplary embodiment of the present disclosure.

FIG. 1 illustrates a perspective view of the lifting chair or power assist recliner 100 with a leg supporting component open for feet raise, in accordance with an exemplary embodiment of the present disclosure. A lifting chair or power assist recliner 100 (hereinafter referred to as “recliner 100”) includes a seating assembly 110 having a seat 112 and a supporting arrangement 130 operatively coupled to the seating assembly 110.

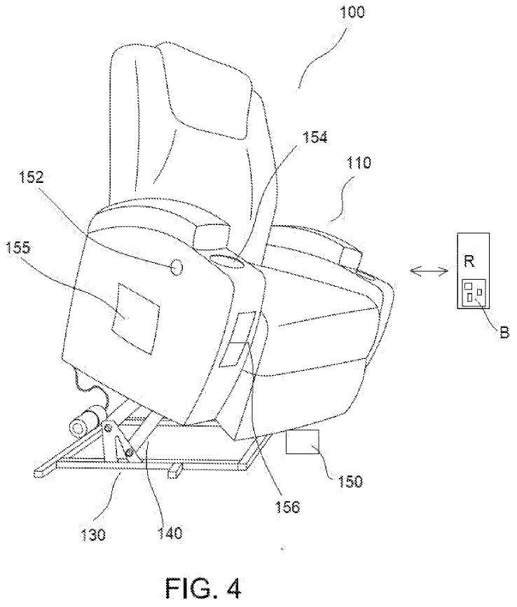

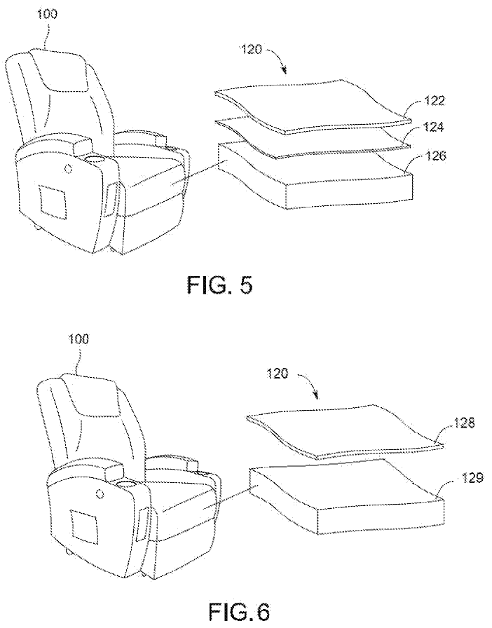

As seen in FIGS. 5 and 6, the seating assembly 110 may include a multilayer comforting arrangement 120 disposed on the seat 112 for providing comfort to a user. The multilayer comforting arrangement 120 comprises at least one layer of a cushioning material known as optron.

Further referring back to FIG. 1, in conjunction to FIGS. 5 and 6, the seating assembling 110 may include a seat 110a, a back rest 110b, a leg supporting component 110c, side arms 110d. The seat 110a may be aligned horizontally. The back rest 110b may extend vertically upward from the seat 110b. The leg supporting component 110c may extends from the seat 110a to be operatively aligned with the seat 110a, and the side arms 110d may extend vertically from sides of the seat. Each of the seat 110a, the back rest 110b, and the leg supporting component 110c are comprises of the multilayer comforting arrangement 120 having at least one layer of the cushioning material known as optron.

In one embodiment, as seen in FIG. 5, the multilayer comforting arrangement 120 comprises at least three layers, a first layer 122, a second layer 124, and a third layer 126. The second layer 124 is sandwiched between the first layer 122 and the third layer 126. The second layer 124 is of the cushioning material known as the optron which when paired with the first layer 122 and the third layer 126 adds additional comfort and reduces fatigue. The first layer 122 may be a fabric layer, and the third layer 126 may be a memory foam.

One another embodiment, as seen in FIG. 6, the multilayer comforting arrangement 120 includes at least two layers, a top layer 128 and a bottom layer 129. The top layer 128 is disposed above a bottom layer 129. The top layer 128 is of the cushioning material known as the optron which when paired with the bottom layer 129 adds additional comfort and reduces fatigue. The bottom layer 129 is a memory foam.

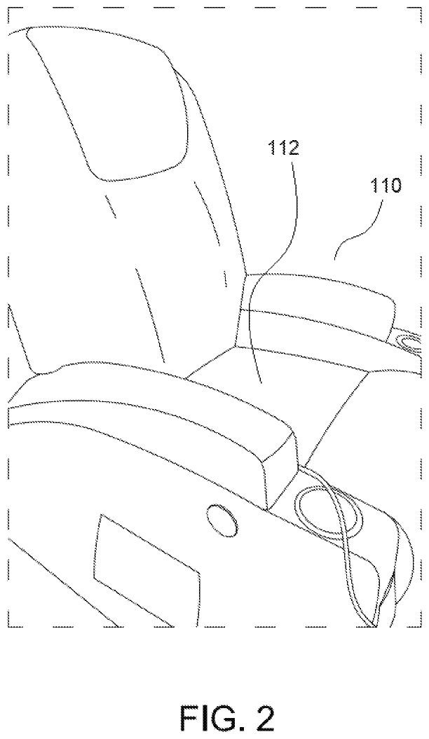

Referring now to FIGS. 2 to 4, and in conjunction to FIG. 1, the recliner 100 further includes the supporting arrangement 130 attached to the seating assembly 110. The supporting arrangement 130 comprises a lifting arrangement 140 operably secured to the supporting arrangement 130. The lifting arrangement 140 mechanically actuates and lift or rotate the seating assembly 110 at a pre-set level depending on the user's physique and comfort. The lifting arrangement 140 is configured to actuate and rotate the seating assembly 110 comprising the multilayer comforting arrangement 120 according to comfort of the user.

In one example, the seating assembly 110 may be automatically rotated and actuated depending on the comfort of the user. In another example, the seating assembly 110 may be manually operated using a remote control “R” for rotation and actuation depending on the comfort of the user.

The recliner further includes a heating and/or massaging member 150 controlled by a remote control “R” with heat and/or massage buttons “B”, at least three USB ports 152, two or more cup holders 154, a side pocket 155, at least two front pockets 156 arranged along the seating assembly 110.

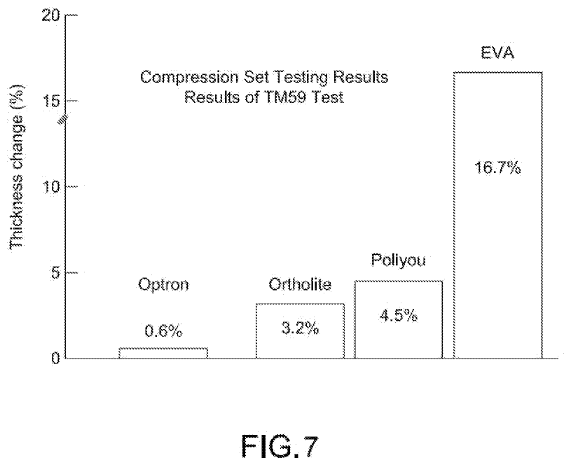

FIG. 7 illustrates a graph showing the compression set testing result of at least one layer of the cushioning material known as optron, according to embodiments of the present invention. The cushioning material may be compressed by 0.6 percent when put through the compression test. The at least one layer of the cushioning material known as optron may be a special cushioning substance that may be specially developed to increase comfort and lessen fatigue when mixed with other foams. The quickest, cheapest approach to increase comfort is with optron. Such layer additionally offers superior compression set performance compared to other materials.

The at least one layer of the cushioning material known as optron may be made of single and multi-density polyurethane, which provides better cushioning to maximize comfort.

The at least one layer of the cushioning material known as optron may reduce shock and offer outstanding energy returns for peak performance. The at least one layer of the cushioning material known as optron may also be made of microcellular polyurethane, which provides greater cushioning to maximize comfort. Independent laboratory testing show Optron delivers higher compression set performance compared to the other materials, maintaining the shape for comfort for a longer period of time. The at least one layer of the cushioning material known as optron is of multi-density construction that may provide crucial areas additional support and comfort. Additionally, at least one layer of the cushioning material known as optron is of static dissipative qualities.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

What is claimed:

1. A lifting chair or power assist recliner comprising:
a seating assembly having a seat, the seating assembly including a multilayer comforting arrangement disposed on the seat for providing comfort to a user, wherein the multilayer comforting arrangement comprises at least one layer of a cushioning material known as optron;
a supporting arrangement attached to the seating assembly, the supporting arrangement comprises a lifting arrangement operably secured to the supporting arrangement, wherein the lifting arrangement mechanically actuates and lift or rotate the seating assembly at a pre-set level depending on the user's physique and comfort.

2. The lifting chair or power assist recliner of claim 1, wherein the seating assembling comprises:
a seat aligned horizontally,
a back rest extends vertically upward from the seat,
a leg supporting component extends from the seat to be operatively aligned with the seat, and
side arms extend vertically from sides of the seat,
wherein each of the seat, the back rest, and the leg supporting component comprises the multilayer comforting arrangement having the at least one layer of the cushioning material known as optron.

3. The lifting chair or power assist recliner of claim 1, wherein the multilayer comforting arrangement comprises at least three layers, a first layer, a second layer, and a third layer, wherein the second layer is sandwiched between the first layer and the third layer, and wherein
the second layer is of the cushioning material known as the optron which when paired with the first layer and the third layer adds additional comfort and reduces fatigue,
the first layer is a fabric layer, and
the third layer is a memory foam.

4. The lifting chair or power assist recliner of claim 1, wherein the multilayer comforting arrangement comprises at least two layers, a top layer and a bottom layer, wherein
the top layer is disposed above a bottom layer,
the top layer is of the cushioning material known as the optron which when paired with the bottom layer adds additional comfort and reduces fatigue,
the bottom layer is a memory foam.

5. The lifting chair or power assist recliner of claim 1, wherein the lifting arrangement is configured to actuate and rotate the seating assembly comprising the multilayer comforting arrangement according to comfort of the user.

6. The lifting chair or power assist recliner of claim 5, wherein the seating assembly is automatically rotated and actuated depending on the comfort of the user.

7. The lifting chair or power assist recliner of claim 5, wherein the seating assembly is manually operated using a remote control for rotation and actuation depending on the comfort of the user.

8. The lifting chair or power assist recliner of claim 1 further comprising a heating and/or massaging member controlled by a remote control with heat and/or massage buttons, at least three USB ports, two or more cup holders, a side pocket, at least two front pockets.

9. A seating assembly for a lifting chair or power assist recliner, the seating assembly comprising:
a seat having a multilayer comforting arrangement disposed on the seat for providing comfort to a user, wherein the multilayer comforting arrangement comprises at least one layer of a cushioning material known as optron.

10. The seating assembling of claim 9 further comprising:
a seat aligned horizontally,
a back rest extends vertically upward from the seat,
a leg supporting component extends from the seat to be operatively aligned with the seat, and
side arms extend vertically from sides of the seat,
wherein each of the seat, the back rest, and the leg supporting component comprises the multilayer comforting arrangement having the at least one layer of the cushioning material known as optron.

11. The seating assembling of claim 9, wherein the multilayer comforting arrangement comprises at least three layers, a first layer, a second layer, and a third layer, wherein the second layer is sandwiched between the first layer and the second layer, and wherein
the second layer is of the cushioning material known as the optron which when paired with the first layer and the third layer adds additional comfort and reduces fatigue,
the first layer is a fabric layer, and
the third layer is a memory foam.

12. The seating assembling of claim 9, wherein the multilayer comforting arrangement comprises at least two layers, a top layer and a bottom layer, wherein the top layer is disposed above a bottom layer,
the top layer is of the cushioning material known as the optron which when paired with the bottom layer adds additional comfort and reduces fatigue,
the bottom layer is a memory foam.
